(19) United States
(12) Patent Application Publication
(10) Pub. No.: US 2013/0030175 A1
(43) Pub. Date: Jan. 31, 2013

(54) METAL-PORPHYRIN CARBON NANOTUBES FOR USE IN FUEL CELL ELECTRODES

(71) Applicant: Korea Advanced Institute of Science & Technology, Daejeon (KR)

(72) Inventors: Yonghyun Kim, Daejeon (KR); Sangouk Kim, Daejeon (KR); Wonjong Lee, Daejeon (KR); Duckhyun Lee, Daejeon (KR); Wonjun Lee, Daejeon (KR)

(73) Assignee: KOREA ADVANCED INSTITUTE OF SCIENCE AND TECHNOLOGY, Daejeon (KR)

(21) Appl. No.: 13/630,627

(22) Filed: Sep. 28, 2012

Related U.S. Application Data
(63) Continuation of application No. PCT/KR2010/003997, filed on Jun. 21, 2010.

(30) Foreign Application Priority Data
May 11, 2010 (KR) 10-2010-0043829

(51) Int. Cl. C07F 15/02; B82Y 30/00

(52) U.S. Cl. 544/225; 977/734; 977/742

(57) ABSTRACT

The present invention provides metal-porphyrin carbon nanostructures, which have excellent oxygen reduction performance and are useful as materials for fuel cell electrodes.

### CROSS-REFERENCE TO RELATED APPLICATIONS

This application is a continuation application of International Application No. PCT/KR2010/003997 filed Jun. 21, 2010, which claims the priority to Korean Patent Application No. 10-2010-0043829 filed May 11, 2010, which applications are incorporated herein by reference.

### TECHNICAL FIELD

The present invention relates to metal-porphyrin carbon nanotubes, and more particularly to metal-porphyrin carbon nanotubes for use in fuel cell electrodes.

### BACKGROUND ART

Platinum (Pt) is known as a preferred example of a material for a fuel electrode. However, platinum has disadvantages of rarity, high cost, a high overpotential loss, limited reliability, and the like, which make it difficult to use platinum for commercial purposes. Thus, there have been extensive efforts to find alternatives to platinum for use as fuel cell electrodes. Specifically, there have been efforts to develop platinum-based alloys and efforts to develop non-noble metals. The development of platinum-based alloys can be a provisional solution, but the development of non-noble metal catalysts is eventually preferred.

As an example of the development of non-noble metals, Fe-porphyrin-based electrode materials have been proposed. However, these conventional Fe-porphyrin-based materials have been mostly prepared by mechanically mixing Fe-porphyrin carbon materials or attaching Fe-porphyrin to carbon materials, and do not sufficiently function as catalysts. This is because the density of Fe-porphyrin functioning as a catalyst is low and the mechanical and electrical contact of Fe-porphyrin with carbon supports is poor.

### SUMMARY OF THE DISCLOSURE

It is an object of the present invention to solve the above-described problems occurring in the art and to metal-porphyrin carbon nanotubes having an excellent function as catalysts for fuel cell electrodes.

Carbon nanostructures comprise metal-porphyrin embedded in graphitic sidewalls of a hexagonal lattice structure in a 5-6-5-6 form. The carbon nanostructures can be effectively used in applications requiring oxygen reduction reactions. In particular, the carbon nanostructures can be used in fuel cell electrodes.

The carbon nanostructures may be carbon nanotubes or graphenes, which have a hexagonal lattice structure. Moreover, the metal in the metal-porphyrin is preferably iron, and the carbon nanostructures preferably have a nitrogen doping concentration of 4.6 atomic %. In addition, in the carbon nanostructures, iron and nitrogen form an ionic bond with each other, and iron and carbon form a covalent bond with other.

If the carbon nanostructures are multiwalled carbon nanotubes, they preferably have cuts along the side walls thereof in order to enlarge a reaction area.

According to the present invention, it is possible to embed a large amount of metal-porphyrin in the hexagonal lattice sidewall structure of carbon nanotubes in a 5-6-5-6 form. Thus, when the carbon nanostructures of the present invention are used as catalysts for fuel cell electrodes, they can exhibit very excellent properties, including excellent oxygen reduction properties and durability. In addition, these carbon nanostructures can be used as inexpensive alternatives to platinum materials.

### BRIEF DESCRIPTION OF DRAWINGS

FIG. 1 shows the structure of metal-porphyrin carbon nanotubes according to the present invention.

FIG. 2 shows the XPS spectra of carbon nanotubes at various nitrogen doping concentrations.

FIG. 3 shows the XPS spectra of iron of carbon nanotubes at various nitrogen doping concentrations.

FIG. 4 shows calculated defect formation energy as a function of nitrogen chemical potential.

FIG. 5 shows the calculated energy band structures of carbon nanotubes according to the present invention and other materials.

FIG. 6 shows the work function of carbon nanotubes, measured by UPS.

FIG. 7 shows cyclic voltammograms.

FIG. 8 shows rotating disk electrode voltammograms.

FIG. 9 shows the coupling of ligands, such as oxygen molecules, oxygen atoms and hydroxyl groups, to metal-porphyrin carbon nanotubes according to the present invention.

### DETAILED DESCRIPTION OF THE DISCLOSURE

Hereinafter, preferred embodiments of the present invention will be described with reference to the accompanying drawings. The present invention is described by way of example of metal-porphyrin carbon nanotubes comprising iron (Fe) among metals, and the detailed description of metal-porphyrin carbon nanotubes comprising other methods will be omitted, because it does not differ from that of metal-porphyrin carbon nanotubes comprising iron. However, it is to be understood that metal-porphyrin carbon nanotubes comprising metals other than iron also fall with the scope of the present invention.

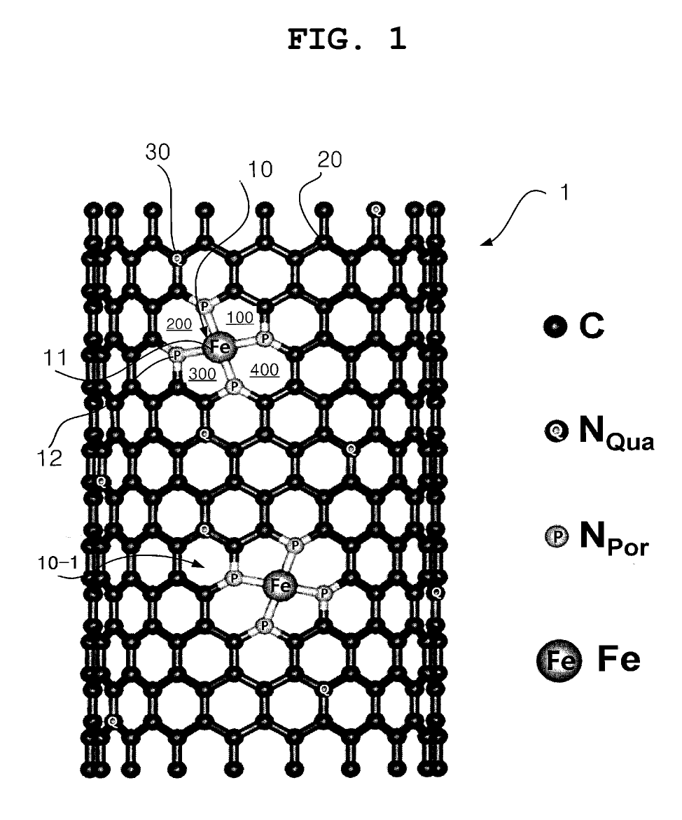

FIG. 1 shows the structure of Fe-porphyrin carbon nanotubes. In actual, multiwalled carbon nanotubes are produced, but in FIG. 1, only one sidewall is shown for convenience of description.

As shown in FIG. 1, iron (Fe)-porphyrin carbon nanotubes 1 according to the present invention comprises Fe-porphyrin 10 embedded in the sidewalls of conventional carbon nanotubes. As used herein, the term “embedded” means that Fe-porphyrin is seamlessly inserted into the sidewalls of carbon nanotubes as shown in FIG. 1. Fe-porphyrin 10 comprises iron 11 placed at the center and four porphyrinic nitrogen atoms 12 bonded to the iron 11 in a rectangular form. Herein, each of the porphyrinic nitrogen atoms 12 forms a bond with the carbon of the carbon nanotubes 1. The iron 11 has a valence of +2 and forms an ionic bond with the porphyrinic nitrogen 12, and the nitrogen 12 forms a covalent bond with carbon. Because such bonds are formed, the Fe-porphyrin 10 is embedded in the hexagonal graphene sidewalls of the carbon nanotubes 1 in a 5-6-5-6 form as shown in FIG. 1. As used herein, the term “5-6-5-6 form” means that the lattice structures around the Fe-porphyrin 10 have pentagonal-hexagonal-pentagonal-hexagonal forms, respectively. In other words, as shown in FIG. 1, it means that the Fe-porphyrin 10 is embedded in such a manner that a first structure 100, a second structure 200, a third structure 300 and a fourth structure 400, which surround the iron 11, have pentagonal, hexagonal, pentagonal and hexagonal shapes, respectively. These structures are similar to honeycomb (hexagonal) lattice structures. Specifically, even when the Fe-porphyrin 10 is embedded in the sidewalls of the carbon nanotubes 1 according to the present invention, there is no significant change in the honeycomb structure of the carbon nanotubes 1. In addition, a large number of the Fe-porphyrin can embedded in the carbon nanotubes 1 by seamless embedding. As the number of the Fe-porphyrin 10 embedded in the sidewalls of the carbon nanotubes 1 increases, the function of the carbon nanotubes 1 as catalysts for fuel cell electrodes becomes more excellent.

Meanwhile, the amount of Fe-porphyrin embedded in the carbon nanotubes 1 according to the present invention changes depending on the nitrogen doping concentration of the carbon nanotubes 1. The present inventors determined the nitrogen doping concentration, which has the above critical significance, using the following method.

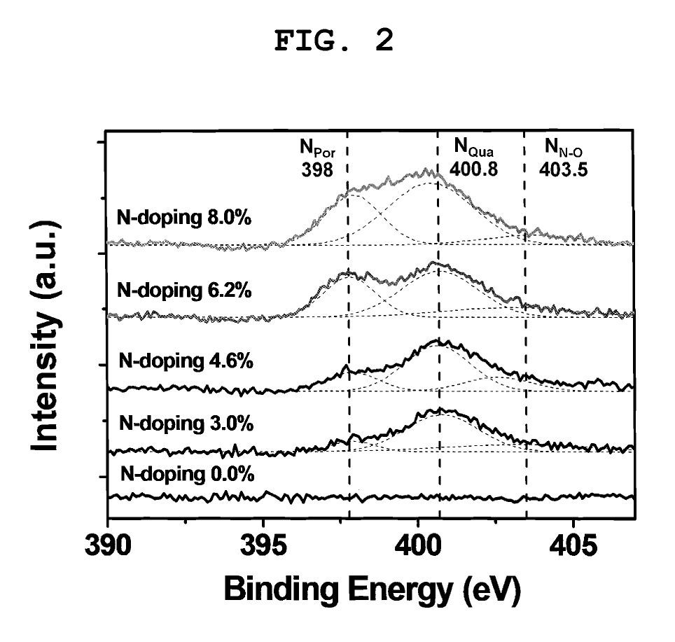

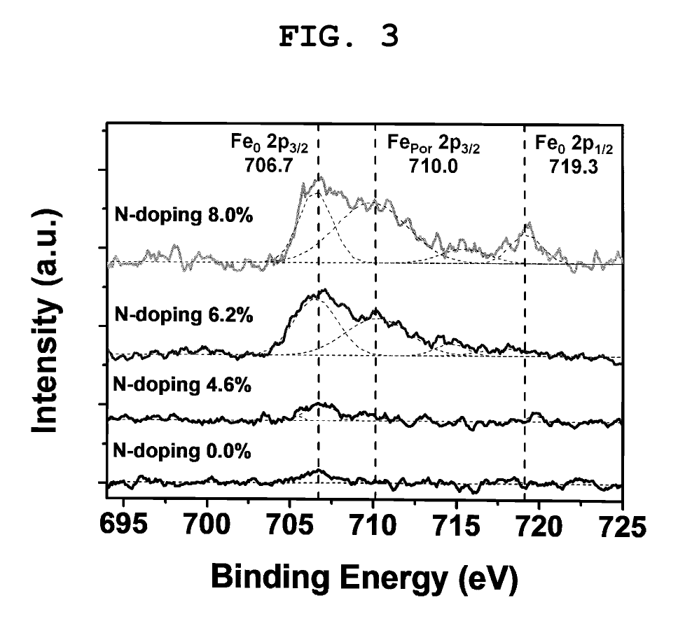

FIGS. 2 and 3 show X-ray photoelectron spectroscopy (XPS) spectra of nitrogen and iron of carbon nanotubes at various nitrogen doping concentrations, respectively.

There are the following four types of nitrogen, which are doped into the sidewalls of the carbon nanotubes: quaternary nitrogen (N_{Qua}), porphyrin nitrogen (N_{Por}), pyrollic nitrogen (N), and nitrogen oxide (N_{N-O}). As shown in FIG. 2, the Fe-porphyrin carbon nanotubes 1 according to the present invention show three peak values for N_{Por}, N_{Qua} and N_{N-O}. The peak values of iron are divided into two core electrode-state peak values and one oxidation-state (+2) peak value for porphyrin iron (F_{Por}).

As shown in FIGS. 2 and 3, at a nitrogen doping concentration of less than 4.6 atomic %, the N_{Qua} peak dominantly grows the nitrogen doping concentration. In contrast, at a nitrogen doping concentration of 4.6 atomic % or more, the N_{Por} peak value suddenly grows along with the Fe_{Por} peak. This suggests that the formation of 5-6-5-6 Fe-porphyrin units is active at a nitrogen doping concentration of 4.6 atomic % or more.

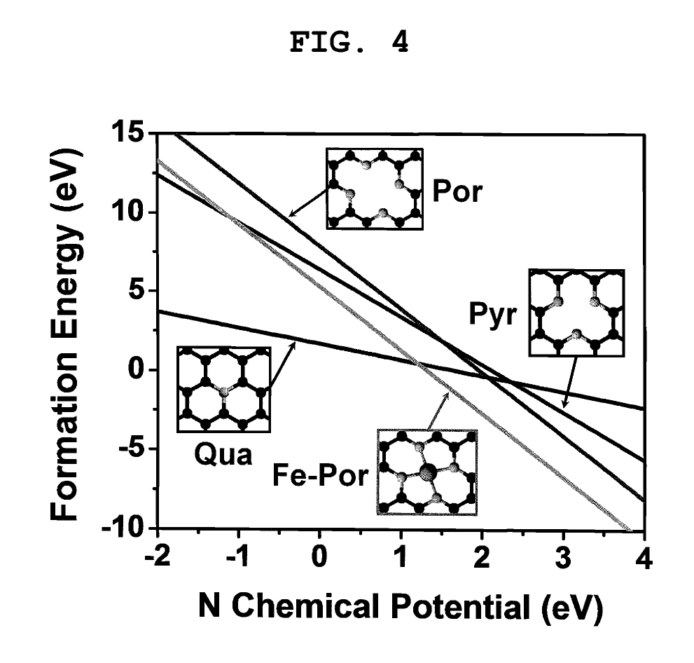

The formation of Fe-porphyrin carbon nanotubes can also be investigated by first-principles density-functional (DFT) calculations. FIG. 4 shows calculated defect formation energy as a function of nitrogen (N) chemical potential (μ_{N}). As can be seen in FIG. 4, when the nitrogen chemical potential (μ_{N}) is low, the dominant lowest energy defect species is N_{Qua}, and as μ_{N} increases, a crossover takes place from N_{Qua} to Fe-porphyrin. This rationalizes the trend observed in the above-described XPS results.

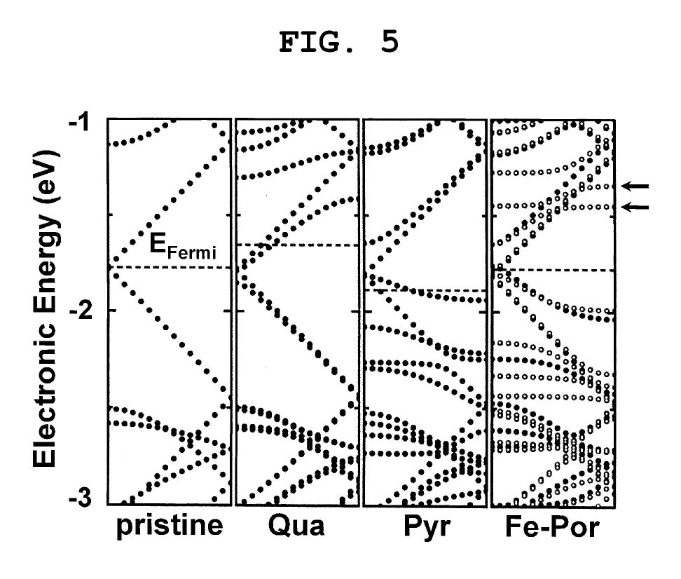

FIG. 5 shows the calculated energy band structures of the Fe-porphyrin carbon nanotubes according to the present invention and other types of nitrogen-doped carbon nanotubes and pristine carbon nanotubes. The dotted lines in FIG. 5 indicate the Fermi energy of each of the carbon nanotubes. As can be seen in FIG. 5, in the case of the N_{Qua}-doped carbon nanotubes, N_{Qua} serves as an electron donor, and in the case of the N_{Pyr}-doped carbon nanotubes, N_{Pyr} functions as an electron acceptor. In the case of the Fe-porphyrin carbon nanotubes, the Fermi energy level is substantially the same as that of the pristine carbon nanotubes, suggesting that the Fe-porphyrin carbon is a charge-neutral defect.

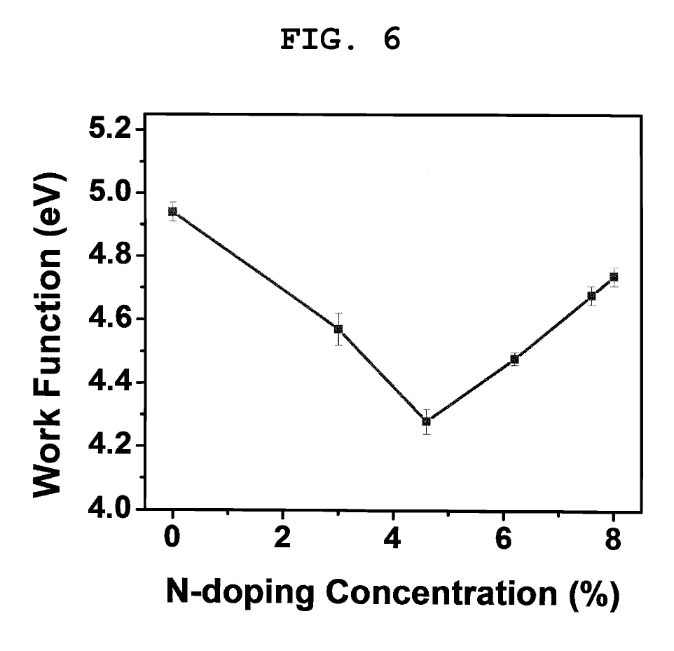

Meanwhile, FIG. 6 shows the work function of the carbon nanotubes according to the present invention, measured by UV photoemission spectroscopy. As can be seen in FIG. 6, when the N-doping concentration is below 4.6%, the electron-donating N_{Qua} dominates, and thus the Fermi level increases up to 0.8 eV. The increased Fermi energy level results in a decrease in the work function. This can be seen in FIG. 6. In contrast, when the N-doping concentration is above 4.6%, the charge-neutral Fe-porphyrin defects as described above are additionally produced. However, the Fermi level which increased by the N_{Qua} defects is compensated and thus lowered by filling the minority-spin Fe d state of the Fe-porphyrin defects. This is because the originally empty minority-spin state of Fe is filled with electrons. Consequently, the neutral Fe-porphyrin defect acts as an electron acceptor in N-doped carbon nanotubes.

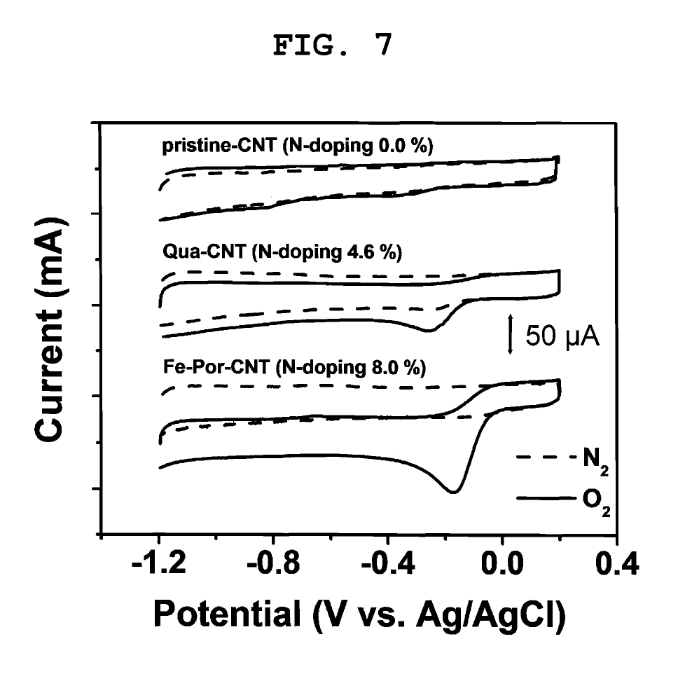

In order to measure the oxygen reduction characteristics of the Fe-porphyrin carbon nanotubes 1 according to the present invention, the comparison of the Fe-porphyrin carbon nanotubes with pristine carbon nanotubes and N_{Qua}-doped carbon nanotubes was carried out using a vertical 10 μm-long Fe-porphyrin as an electrode material. As a result, in the nitrogen-saturated solution, no salient feature was observed for all samples, but in the oxygen-saturated 0.1 M KOH solution (scan rate: mV/s), the oxygen reduction current of the Fe-porphyrin carbon nanotubes was the highest (see FIG. 7).

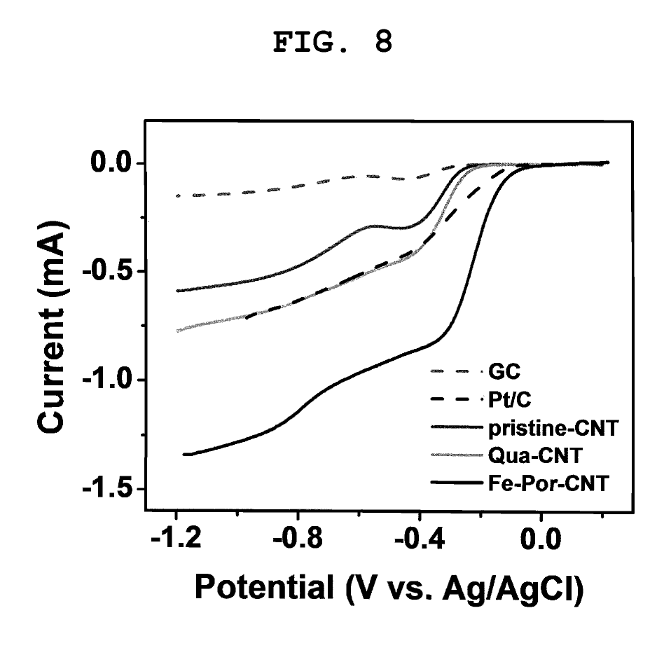

FIG. 8 shows rotating disk electrode voltammograms. The test was carried out in an oxygen-saturated 0.1 M KOH solution at an electrode rotation rate of 1600 RPM. As shown in FIG. 8, the Fe-porphyrin carbon nanotubes showed the largest current drop at the lowest voltage.

The above results indicate that the Fe-porphyrin carbon nanotubes according to the present invention are the best oxygen reduction catalysts in terms of the overpotential and the reduction current.

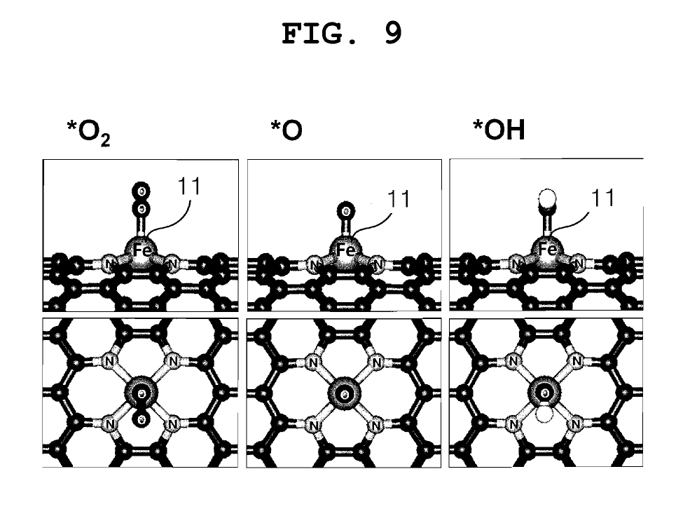

Meanwhile, the inventive carbon nanotubes comprising the Fe-porphyrin embedded therein in a 5-6-5-6 form, a ligand can be coupled to the Fe. As shown in FIGS. 9(a), 9(b) and 9(c), examples of this ligand include an oxygen molecule (O₂), an oxygen atom, or a hydroxyl group (OH). When this ligand is coupled, the inventive carbon nanotubes comprising the Fe-porphyrin embedded therein in a 5-6-5-6 form are easily bonded to other materials so that the application thereof is significantly increased. It is to be understood that the ligand that can be coupled to the metal (such as Fe) of the inventive carbon nanotubes is not limited to the materials in FIG. 9, and any ligand may be used in the present invention, as long as it can be coupled to the metal of the carbon nanotubes.

The Fe-porphyrin carbon nanotubes according to the present invention can be produced in the following manner.

First, nanopatterned Fe nanoparticles were prepared on a silicon oxide substrate by block copolymer lithography. The process of producing the Fe-porphyrin carbon nanotubes according to the present invention can be performed using the process disclosed Korean Patent Application No. 10-2009-0050354 filed in the name of the applicant. Carbon nanotubes are grown from the Fe catalyst by the plasma-enhanced chemical vapor deposition process disclosed in the above patent application. The substrate was heated to 600° C. under a flow of a hydrogen/ammonia gas mixture. Herein, the chamber pressure is maintained at 0.4 torr. The ammonia content varies between 0 and 50 vol %, and the total flow rate of the atmospheric gas is 100 sccm. The substrate is annealed at 600° C. to agglomerate Fe particles. For growth of carbon nanotubes and Fe-porphyrin carbon nanotubes, the chamber pressure is increased to 4.5 torr, and the DC plasma is activated with an anode DC voltage of 470 V relative to the grounded substrate. Slow streaming of acetylene source gas at a flow rate of 5 sccm leads to the production of highly dense Fe-porphyrin carbon nanotubes.

Meanwhile, the Fe-porphyrin carbon nanotubes according to the present invention are generally produced to have a plurality of sidewalls. In order for the Fe-porphyrin carbon nanotubes to be more effectively used in fuel cell electrodes, cuts are preferably formed along the length direction of the carbon nanotubes. The cuts allow the rolled carbon nanotubes to be unrolled, thus increasing the exposure of the Fe-porphyrin embedded in the carbon nanotubes. This can improve the oxygen reduction performance of the Fe-porphyrin carbon nanotubes.

According to the present invention, Fe-porphyrin can be embedded in carbon nanotubes in a 5-6-5-6 form as described above. In addition, it can also be embedded in graphene having a hexagonal lattice structure in the same form, and this graphene having Fe-porphyrin embedded therein can also be used as a material for fuel cell electrodes.

Furthermore, the carbon nanotubes of the present invention can be used not only in fuel cell electrodes, but also in other applications requiring oxygen reduction reductions.

Although the preferred embodiments of the present invention have been described with reference to the accompanying drawings, it is to be understood that the scope of the present invention is not to be construed to be constructed to these embodiments and/or the accompanying drawings and should be determined by the appended claims. In addition, those skilled in the art will appreciate that various modifications, additions and substitutions are possible, without departing from the scope and spirit of the invention as disclosed in the accompanying claims.

1. Carbon nanostructures comprising metal-porphyrin embedded in a hexagonal lattice-structure sidewall thereof in a 5-6-5-6 form.

2. The carbon nanostructures of claim 1, wherein the carbon nanostructures are carbon nanotubes.

3. The carbon nanostructures of claim 2, wherein the sidewall of the carbon nanostructures has cuts along a length direction thereof.

4. The carbon nanostructures of claim 1, wherein the carbon nanostructures are graphene.

5. The carbon nanostructures of claim 1, wherein the metal is iron (Fe).

6. The carbon nanostructures of claim 5, wherein the carbon nanostructures are carbon nanotubes.

7. The carbon nanostructures of claim 6, wherein the sidewall of the carbon nanostructures has cuts along a length direction thereof.

8. The carbon nanostructures of claim 5, wherein the carbon nanostructures are graphene.

9. The carbon nanostructures of claim 5, wherein a ligand is coupled to the iron.

10. The carbon nanostructures of claim 9, wherein the ligand is any one of an oxygen molecule, an oxygen atom and a hydroxyl group.

11. The carbon nanostructures of claim 5, wherein the carbon nanostructures have a nitrogen doping concentration of 4.6 atomic % or more.

12. The carbon nanostructures of claim 11, wherein the carbon nanostructures are carbon nanotubes.

13. The carbon nanostructures of claim 12, wherein the sidewall of the carbon nanostructures has cuts along a length direction thereof.

14. The carbon nanostructures of claim 11, wherein the carbon nanostructures are graphene.

15. The carbon nanostructures of claim 11, wherein a ligand is coupled to the iron.

16. The carbon nanostructures of claim 15, wherein the ligand is any one of an oxygen molecule, an oxygen atom and a hydroxyl group.

17. The carbon nanostructures of claim 5, wherein the carbon nanostructures have an ionic bond between iron and nitrogen and a covalent bond between nitrogen and carbon.

18. The carbon nanostructures of claim 17, wherein the carbon nanostructures are carbon nanotubes.

19. The carbon nanostructures of claim 18, wherein the sidewall of the carbon nanostructures has cuts along a length direction thereof.

20. The carbon nanostructures of claim 17, wherein the carbon nanostructures are graphene.

21. The carbon nanostructures of claim 17, wherein a ligand is coupled to the iron.

22. The carbon nanostructures of claim 21, wherein the ligand is any one of an oxygen molecule, an oxygen atom and a hydroxyl group.
